(19) United States
(12) Patent Application Publication
(10) Pub. No.: US 2022/0191035 A1
(43) Pub. Date: Jun. 16, 2022

(54) SYSTEMS AND PROCESSES FOR MANAGEMENT OF DIGITAL OR PHYSICAL ASSETS VIA DISTRIBUTED LEDGER

(71) Applicants: Luke David TUCKER, London (GB); Elliott John PICKARD, London (GB)

(72) Inventors: Luke David TUCKER, London (GB); Elliott John PICKARD, London (GB)

(21) Appl. No.: 17/593,790

(22) PCT Filed: Apr. 9, 2020
(86) PCT No.: PCT/EP2020/060296

§ 371 Date: Sep. 24, 2021

Related U.S. Application Data
(60) Provisional application No. 62/831,317, filed on Apr. 9, 2019.

(51) Int. Cl. H04L 9/32; H04L 9/08; H04L 9/14; H04L 9/06

(52) U.S. Cl. CPC H04L 9/3236; H04L 9/3297; H04L 9/0825; H04L 2209/38; H04L 9/0643; H04L 9/3218; H04L 9/14

(57) ABSTRACT

In various embodiments, the disclosed system facilitates the access, creation, addition, deletion, revision, security, availability, integrity, registration, conclusion, validation, and notification of certain digital assets, such as an individual's consent for use or reuse or personal information, legal documentation, on a distributed ledger or blockchain system by using cross-party authentication of both a creator's and validator's unique identifying information. In general, in multiple embodiments, the disclosed system provides the ability to update details to documentation in real time, improves security through private key encryption and the implementation of a distributed ledger, and makes the documentation an immutable record. As described in detail herein, aspects of the technology are particularly suited to certain legal documents or instruments that require witnesses, validation, and truth and accuracy in modification or edits, though it will be appreciated that the technology is not strictly limited to legal documentation.

### CROSS REFERENCE TO RELATED APPLICATIONS

This application claims the benefit of, and priority to, the U.S. Provisional Patent Appln. No. 62/831,317, filed on Apr. 9, 2019, and entitled “SYSTEMS AND METHODS FOR MANAGEMENT OF DIGITAL OR PHYSICAL ASSETS VIA A DISTRIBUTED LEDGER,” the disclosure of which is incorporated by reference herein in its entirety.

### TECHNICAL FIELD

The present systems and methods relate generally to distributed ledger technology, and more particularly to the use of distributed ledger technology to manage digital or physical assets, such as wills or other legal documentation.

### BACKGROUND

Documentation of any kind, whether a paper copy or digital copy, can be lost, destroyed, easily corrupted, redistributed, or misused mistakenly or purposefully, making the validity of a document relatively easy to challenge. Additionally, documentation is often only accessible via a physical copy or through a small number of electronic access points, and the end documentation is rarely encrypted. When legal documents are lost, destroyed, or altered, litigation typically ensues, which leads to unnecessary costs and hassle on behalf of owners/managers of documentation or other digital or physical assets.

One area in which this is particularly problematic is with respect to wills or other estate documents. These types of testation documents are particularly vulnerable to fraud given that the testator is usually deceased when the wills are probated. Although many laws require witness participation when such documents are created or edited, there are many opportunities for witness signatures to be forged, or for documents to be edited or modified in unscrupulous ways, thereby leading to significant concerns around the validity and authenticity of wills and other such documents.

Therefore, there is a long-felt but unresolved need for a system or method that securely manages digital or physical assets, such as legal documentation, and creates an immutable record of the document to prevent fraud or misuse.

### BRIEF SUMMARY OF THE DISCLOSURE

Briefly described, and according to one embodiment, aspects of the present disclosure generally relate to systems and methods for the use of distributed ledger technology to manage physical or digital assets or documents, such as personal data, legal wills or other legal documentation.

In various embodiments, the disclosed system facilitates the access, creation, addition, deletion, revision, security, availability, integrity, registration, conclusion, validation, and notification of certain digital assets, such as an individual's consent for use or reuse or personal information, legal documentation, on a distributed ledger or blockchain system by using cross-party authentication of both a creator's and validator's unique identifying information. In general, in multiple embodiments, the disclosed system provides the ability to update details to documentation in real time, improves security through private key encryption and the implementation of a distributed ledger, and makes the documentation an immutable record. As described in detail herein, aspects of the technology are particularly suited to certain legal documents or instruments that require witnesses, validation, and truth and accuracy in modification or edits, though it will be appreciated that the technology is not strictly limited to legal documentation.

According to one embodiment, a relevant document and disclosed system will be accessible via any device that is capable of storage and execution of the distributed ledger technology or the underlying software, including but not limited to mobile, tablet, laptop, desktop, server, service, interface, machine learning system, hardware chip, artificial intelligence system, artificial neural network, or other equivalent device used for accessing information and updating information. In some embodiments, the ledger also has a common search location to those looking for the existence of a document. In multiple embodiments, the disclosed system also facilitates compliance of the creation and revision of documents across jurisdictions.

In various embodiments, a user (sometimes referred to herein as the “creator”) who desires to give consent for personal data to be accessed and used, may create a document and add the document onto the distributed ledger of the disclosed system inputs personal identification information for himself/herself and inputs personal identification information and identification requirements for a second user (sometimes interchangeably referred to herein as the “validator” or “actor”, where a validator is a type of actor). In some embodiments, the validator or actor then inputs personal identification information. In multiple embodiments, the creator and validator then, generally, cross validate each other, to protect against any fraud by any malicious third parties. The cross validation protects against fraud, in at least one embodiment, by allowing the creator to verify that the validator's identification that was input into the system matches the identification known to the creator. For example, in one embodiment, the creator may cause the system to engage with a third party, but the creator may accidentally input the wrong identification information for the validator or actor into the system, so that a wrong individual is engaged as the validator or actor. Continuing with the same example, because the wrong individual still has to input personal identification information, the creator will verify that the wrong individual received the engagement from the system and end the transaction before the wrong individual can affect the system.

In another example, a bad actor may have maliciously hacked into either one of the creator or validator's devices, or disintermediated either one of the creator or validator through a proxy operated by the bad actor, to purposefully attempt to affect the documentation into a block on the distributed ledger process. Again, in this example, the creator may foil the malicious third party by ending the transaction before validating the incorrect validator's information. In various embodiments, it may be necessary to end the transaction before the document is added to the distributed ledger with the wrong validator information attached because the correct validator will not be able to access the document upon a crystallization event (further described below), and because the wrong validator may have access to the document on the ledger and fraudulently affect the document in some way.

In various embodiments, the process used in creation of the ledger entries and the nonce in the present disclosure improve the processing and performance of a distributed ledger compared to traditional methods due to the non-reliance on traditional blockchain mining activities, where traditional block chains mining activities rely on the systematic computational power of unverified nodes to resolve the next ledger entry, which requires a significant and accumulative processing effort. For example, in multiple embodiments, the system of the present disclosure allows for the creator to predefine the difficulty of effort required to create a ledger entry by predetermining the number of actors used in the validation process, where one or more actors each fulfil a set of similar or different challenges successfully, coupled with the creator to confirming the validity of each actor. In several embodiments, the system of the present disclosure may reduce the underlying processing required to produce a distributed ledger and may reduce energy consumption in computing power used to validate a ledger.

According to one aspect, a method for managing digital assets on a distributed ledger, comprising: receiving and/or generating first data at a first computing device associated with a first actor, the first data comprising first identification data corresponding to the first actor, identifying data corresponding to a second actor, and digital asset data defining a digital asset to be maintained on the distributed ledger; transmitting the first identification data to a second computing device associated with the second actor; receiving and/or generating second data at the second computing device, the second data comprising second identification data corresponding to the second actor and a confirmation that the second actor has performed a successful validation operation of the first identification data; transmitting the second identification data to the first computing device; receiving and/or generating a confirmation at the first computing device that the first actor has performed a successful validation operation of the second identification data; generating a block data set based on the first identification data, the second identification data, and the digital asset data; and adding the block data set to the distributed ledger.

According to another aspect, the method of any aspect, further comprising: encrypting the first identification data prior to transmitting the first identification data to the second computing device; and enabling decryption of the first identification data at the second computing device upon determination of authorized access to the first identification data by the second actor.

According to yet another aspect, the method of any aspect, further comprising: encrypting the second identification data prior to transmitting the second identification data to the first computing device; and enabling decryption of the second identification data at the first computing device upon determination of authorized access to the second identification data by the first actor.

According to yet another aspect, the method of any aspect, wherein the successful validation operation of the first identification data comprises confirmation of one or more correct answers and/or actions to one or more validation questions and/or validation tasks from the second actor with respect to the first identification data.

According to yet another aspect, the method of any aspect, wherein the successful validation operation of the second identification data comprises confirmation of one or more correct answers and/or actions to one or more validation questions and/or validation tasks from the first actor with respect to the second identification data.

According to yet another aspect, the method of any aspect, further comprising, prior to adding the block data set to the distributed ledger: transmitting the block data set to a plurality of computing devices affiliated with the distributed ledger; and receiving confirmation from one or more of the plurality of computing devices that the block data set is valid.

According to yet another aspect, the method of any aspect, wherein the one or more of the plurality of computing devices do not include the first computing device or the second computing device.

According to yet another aspect, the method of any aspect, further comprising: generating a timestamp corresponding to generation of the block data set; and appending the timestamp to the block data set.

According to yet another aspect, the method of any aspect, further comprising: extracting a prev-hash from the distributed ledger; and appending the prev-hash to the block data set.

According to yet another aspect, the method of any aspect, further comprising updating the block data set on the distributed ledger to include the timestamp and the prev-hash.

According to yet another aspect, the method of any aspect, further comprising generating a first private key for the first actor, wherein the first private key is generated as a function of the first identification data, and wherein the first private key is necessary to access the digital asset in the block data set maintained on the distributed ledger.

According to yet another aspect, the method of any aspect, further comprising: receiving and/or generating a request for modification of the digital asset at a computing device associated with the first actor, wherein the request includes the first private key and an indication of the block data set comprising the digital asset; accessing the block data set on the distributed ledger using the first private key; enabling access to the block data set to the first actor for modification of the block data set; and upon modification, updating the block data set on the distributed ledger.

According to yet another aspect, the method of any aspect, further comprising generating a second private key for the second actor, wherein the second private key is generated as a function of the second identification data, and wherein the second private key is necessary to access the digital asset in the block data set maintained on the distributed ledger.

According to yet another aspect, the method of any aspect, wherein the digital asset data includes one or more third parties to be given access to the digital asset upon a crystallization event.

According to yet another aspect, the method of any aspect, further comprising, upon the crystallization event: receiving and/or generating a request for access to the digital asset at a computing device associated with the second actor, wherein the request includes the second private key, an indication of the block data set comprising the digital asset, and proof of the crystallization event; accessing the block data set on the distributed ledger using the second private key; upon successful access to the block data set based on the second private key, retrieving the digital asset from the block data set; and transmitting the digital asset to the one or more third parties.

According to yet another aspect, the method of any aspect, wherein the digital asset comprises a will, estate document, power of attorney, trust, indication of future wishes, guardianship of relatives, or living will.

According to yet another aspect, the method of any aspect, wherein the digital asset comprises instructions relating to transfer of assets.

According to yet another aspect, the method of any aspect, wherein the digital asset comprises a healthcare record or healthcare data.

According to yet another aspect, the method of any aspect, wherein the digital asset comprises an indication of personal preferences of the first actor.

According to yet another aspect, the method of any aspect, wherein the digital asset comprises system or hardware data pertaining to the first computing device of the first actor.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment, according to one embodiment of the present disclosure;

FIG. 2 illustrates an exemplary system overview flowchart, according to one embodiment of the present disclosure;

FIG. 3 illustrates an exemplary process for receiving and encrypting creator information, according to one embodiment of the present disclosure;

FIG. 4 illustrates an exemplary process for receiving validation of a creator, according to one embodiment of the present disclosure;

FIG. 5 illustrates an exemplary process for receiving validation of a validator and creating an initial block data set, according to one embodiment of the present disclosure;

FIG. 6 illustrates an exemplary process for validating an initial block data set, according to one embodiment of the present disclosure;

FIG. 7 illustrates an exemplary process for validating an initial block data set for entry into a consensus, according to one embodiment of the present disclosure;

FIG. 8 illustrates an exemplary process for generating a new block and updating a distributed ledger, according to one embodiment of the present disclosure;

FIG. 9 illustrates an exemplary process for generating public and private keys, according to one embodiment of the present disclosure;

FIG. 10 illustrates an exemplary process for modifying a block on a distributed ledger, according to one embodiment of the present disclosure;

FIG. 11 illustrates an exemplary process for resolving a crystallization event, according to one embodiment of the present disclosure; and

FIG. 12 illustrates an exemplary process for contacting third parties during a crystallization event, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for the use of distributed ledger technology to manage physical or digital assets or documents, such as personal data, legal wills or other legal documentation.

In various embodiments, the disclosed system facilitates the access, creation, addition, deletion, revision, security, availability, integrity, registration, conclusion, validation, and notification of certain digital assets, such as an individual's consent for use or reuse or personal information, legal documentation, on a distributed ledger or blockchain system by using cross-party authentication of both a creator's and validator's unique identifying information. In general, in multiple embodiments, the disclosed system provides the ability to update details to documentation in real time, improves security through private key encryption and the implementation of a distributed ledger, and makes the documentation an immutable record. As described in detail herein, aspects of the technology are particularly suited to certain legal documents or instruments that require witnesses, validation, and truth and accuracy in modification or edits, though it will be appreciated that the technology is not strictly limited to legal documentation.

According to one embodiment, a relevant document and disclosed system will be accessible via any device that is capable of storage and execution of the distributed ledger technology or the underlying software, including but not limited to mobile, tablet, laptop, desktop, server, service, interface, machine learning system, hardware chip, artificial intelligence system, artificial neural network, or other equivalent device used for accessing information and updating information. In some embodiments, the ledger also has a common search location to those looking for the existence of a document. In multiple embodiments, the disclosed system also facilitates compliance of the creation and revision of documents across jurisdictions.

In various embodiments, a user (sometimes referred to herein as the “creator”) who desires to give consent for personal data to be accessed and used, may create a document and add the document onto the distributed ledger of the disclosed system inputs personal identification information for himself/herself and inputs personal identification information and identification requirements for a second user (sometimes interchangeably referred to herein as the “validator” or “actor”, where a validator is a type of actor). In some embodiments, the validator or actor then inputs personal identification information. In multiple embodiments, the creator and validator then, generally, cross validate each other, to protect against any fraud by any malicious third parties. The cross validation protects against fraud, in at least one embodiment, by allowing the creator to verify that the validator's identification that was input into the system matches the identification known to the creator. For example, in one embodiment, the creator may cause the system to engage with a third party, but the creator may accidentally input the wrong identification information for the validator or actor into the system, so that a wrong individual is engaged as the validator or actor. Continuing with the same example, because the wrong individual still has to input personal identification information, the creator will verify that the wrong individual received the engagement from the system and end the transaction before the wrong individual can affect the system.

In another example, a bad actor may have maliciously hacked into either one of the creator or validator's devices, or disintermediated either one of the creator or validator through a proxy operated by the bad actor, to purposefully attempt to affect the documentation into a block on the distributed ledger process. Again, in this example, the creator may foil the malicious third party by ending the transaction before validating the incorrect validator's information. In various embodiments, it may be necessary to end the transaction before the document is added to the distributed ledger with the wrong validator information attached because the correct validator will not be able to access the document upon a crystallization event (further described below), and because the wrong validator may have access to the document on the ledger and fraudulently affect the document in some way.

In various embodiments, the process used in creation of the ledger entries and the nonce in the present disclosure improve the processing and performance of a distributed ledger compared to traditional methods due to the non-reliance on traditional blockchain mining activities, where traditional block chains mining activities rely on the systematic computational power of unverified nodes to resolve the next ledger entry, which requires a significant and accumulative processing effort. For example, in multiple embodiments, the system of the present disclosure allows for the creator to predefine the difficulty of effort required to create a ledger entry by predetermining the number of actors used in the validation process, where one or more actors each fulfil a set of similar or different challenges successfully, coupled with the creator to confirming the validity of each actor. In several embodiments, the system of the present disclosure may reduce the underlying processing required to produce a distributed ledger and may reduce energy consumption in computing power used to validate a ledger.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### Exemplary Embodiments

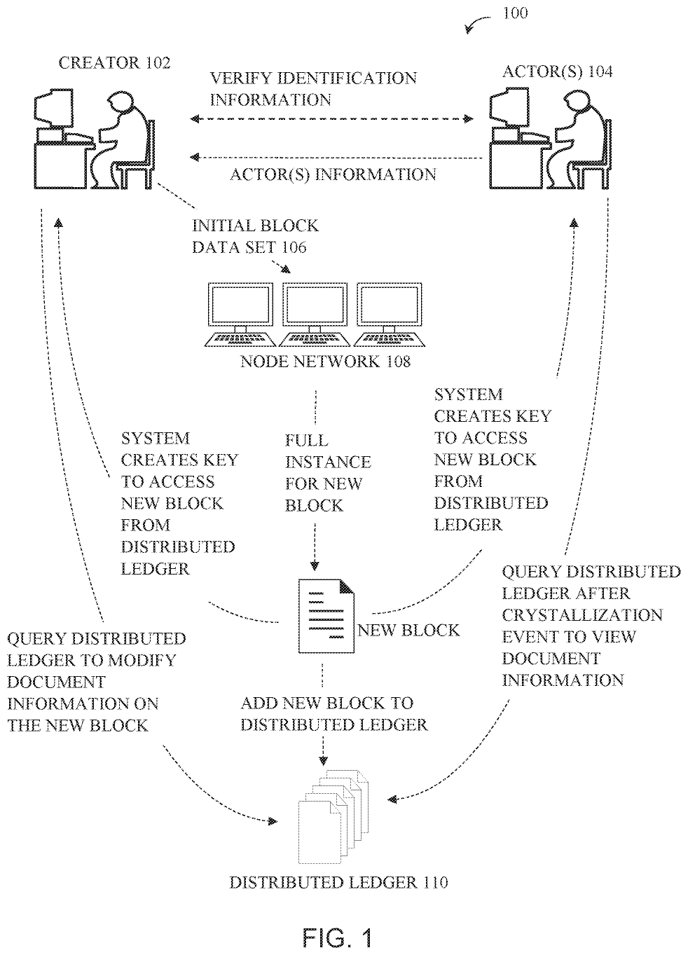

Referring now to the figures, for the purposes of example and explanation of the fundamental processes and components of the disclosed systems and methods, reference is made to FIG. 1, which illustrates an exemplary system environment 100 of one embodiment of the disclosed system. As will be understood and appreciated, the exemplary, high-level overview 100 shown in FIG. 1 represents merely one approach or embodiment of the present system, and other aspects are used according to various embodiments of the present system. For illustrative purposes only, the present disclosure shall describe the disclosed system in the context of a testator creating a will document. No limitations are intended based on the use of this discussion example, which is presented only for ease of illustration and discussion.

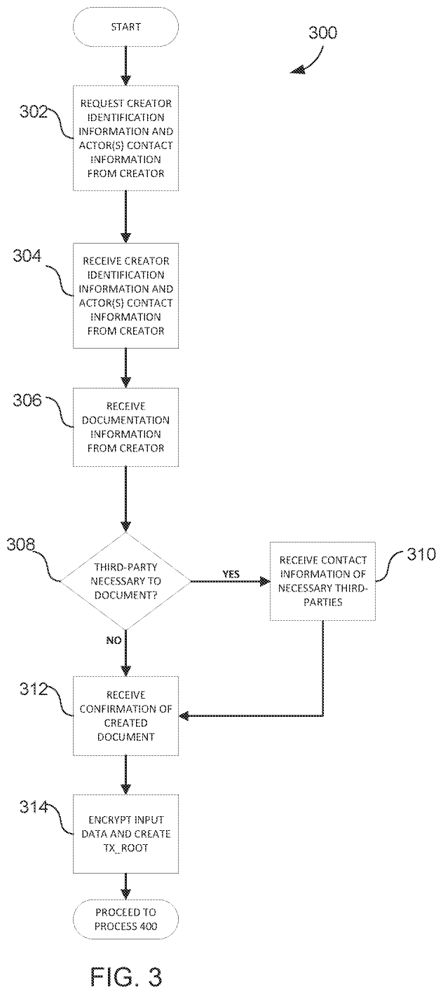

As shown in FIG. 1, according to one embodiment, the creator 102 is an individual who desires to create a document (or other digital asset) on a distributed ledger 110 through the disclosed system. As used in the present disclosure, a document is interchangeable with a digital asset, where a digital asset is a data object or series of data objects that define a collection of data. As a person having ordinary experience in the art will understand, a distributed ledger is a database that exists across multiple locations, where none of the locations are a centralized or main database, and a blockchain is a type of distributed ledger where blocks are appended to the blockchain. In at least one embodiment, the creator 102 engages with the disclosed system via a computing device that is capable of interacting with the distributed ledger 110, such as a mobile, tablet, laptop, desktop, server, system, service, interface, machine learning system, hardware chip, artificial intelligence system, artificial neural network, or other equivalent device. In one or more embodiments, once the creator 102 inputs certain information into the system (e.g., via a software application), the creator 102 causes the system to engage with at least one individual or entity, sometimes referred to herein as an actor or validator 104 (see FIG. 3). Although only one actor is shown in FIG. 1, in several embodiments, the creator may choose to engage multiple actors for one transaction. In multiple embodiments, the creator may engage with multiple actors 104. In some embodiments, the validator or actor 104 engages with the disclosed system via a computing device that is capable of interacting with the distributed ledger 110, such as a mobile, tablet, laptop, desktop, server, service, interface, machine learning system, hardware chip, artificial intelligence system, artificial neural network, or other equivalent device. In several embodiments, the creator 102 and the validator 104 may have a known relationship. As an example, the creator 102 may be a testator and the validator 104 may be the executor to the creator-testator's will or a witness to the will.

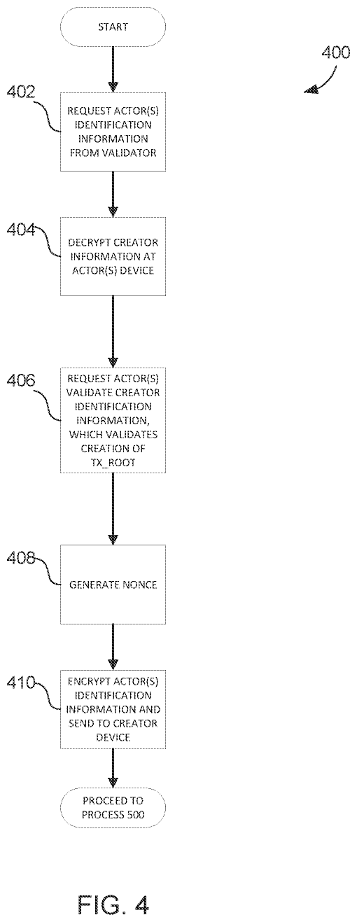

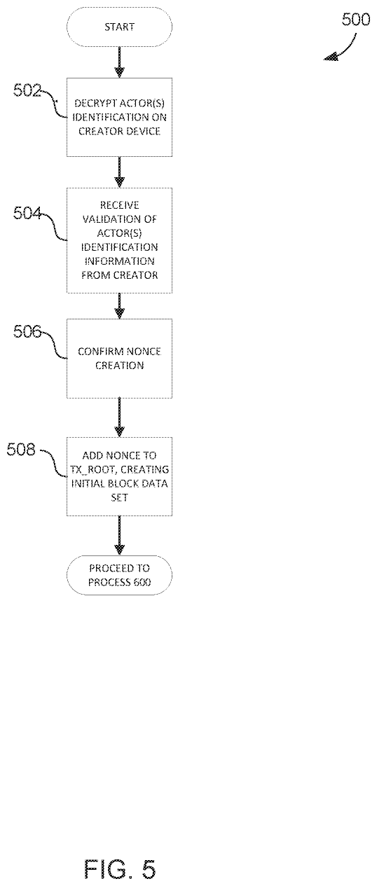

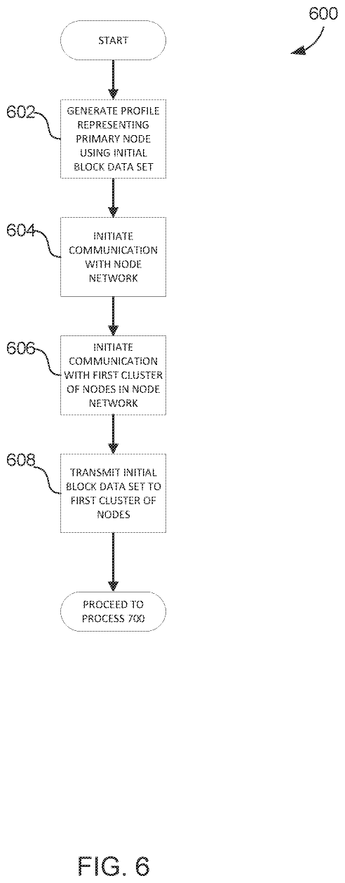

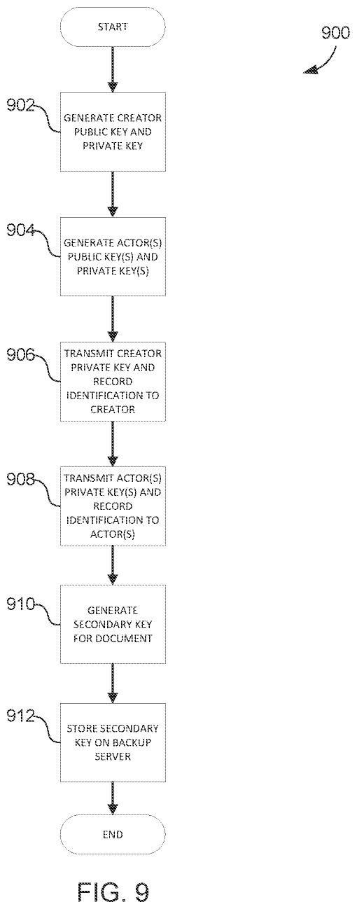

In various embodiments, the creator 102 may transmit, through the disclosed system, identification information to the validator or actor 104, where the validator or actor 104 validates the creator identification information (see FIG. 4). In multiple embodiments, the validator or actor 104 may also enter and send identification data to the creator 102 so that the creator 102 may validate the identification of the validator or actor 104 (see FIG. 5). In some embodiments, the validations of the identification of the creator 102 and the validator or actor 104 are used/combined to create an initial block data set 106 for an initial block creation (also see FIG. 5). In one or more embodiments, the initial block data from the creator 102 may also include other information, including digital asset information to be stored on the distributed ledger 110. In at least one embodiment, the initial block data set 106 is transmitted to a node network 108, where initial block data set 106 is validated (see FIGS. 6-8). In several embodiments, once the initial block data set 106 is validated, the full instance is created for the new block, which is added to the distributed ledger 110. In some embodiments, the system may create one or more separate keys for the creator 102 and the validator or actor 104, so that the creator 102 or validator 104 may access the new block from the distributed ledger 110 once the new block has been added to the distributed ledger 110 (see FIG. 9).

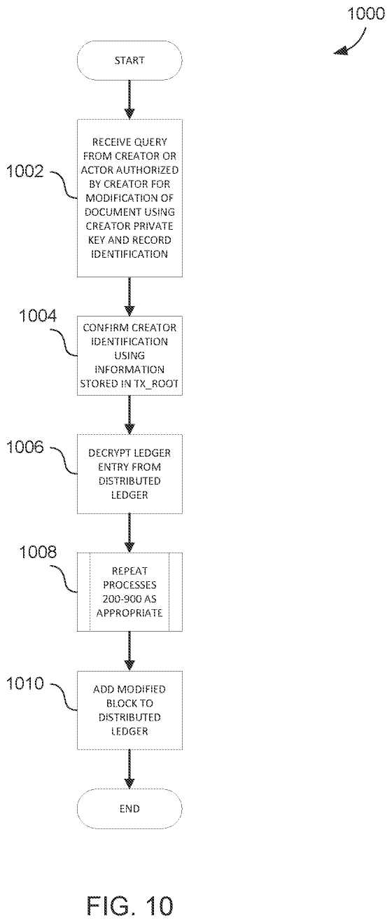

In multiple embodiments, the creator, or an individual authorized by the creator, may modify the digital asset information on the new block (see FIG. 10). In some embodiments, the creator may query the distributed ledger 110 for the digital asset information, and use the creator's one or more keys to access the digital asset information, wherein the creator or authorized individual may modify the document and follow the preceding steps to add the block back onto the distributed ledger 110.

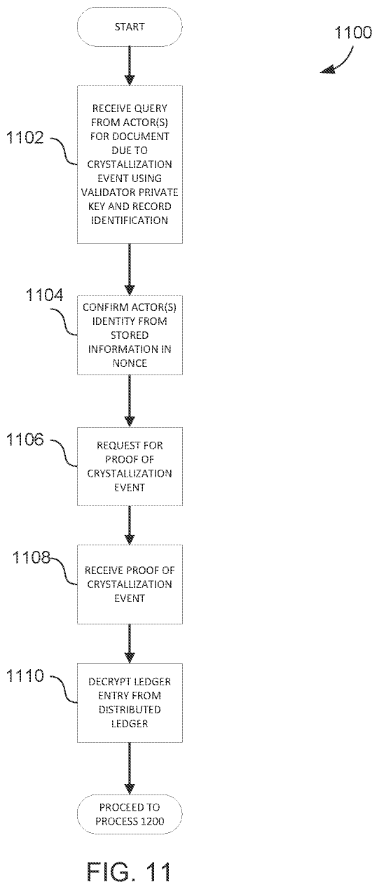

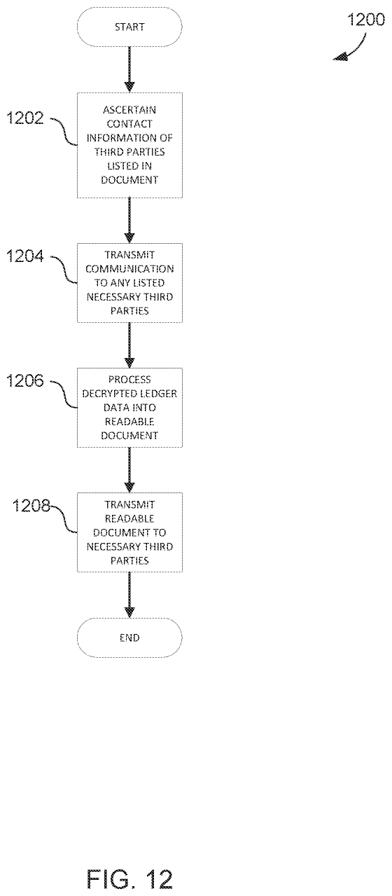

In various embodiments, the validator or actor may access the document information after a crystallization event. In one or more embodiments, a crystallization event may be an event which requires notification to the third parties listed in the document on the distributed ledger 110. For example, in one embodiment involving wills or estate documents, the crystallization event may be the death of the will creator 102. In at least one embodiment, the validator or actor may query the distributed ledger 110 for the digital asset information, and access the digital asset information using the validator's one or more keys (see FIGS. 11-12).

In various embodiments, the disclosed distributed ledger 110 system may operate via a network, such as the Internet, and is carried out by servers, software, applications, services, interfaces, machine learning system, hardware chip, artificial intelligence system, artificial neural network and/or other system components.

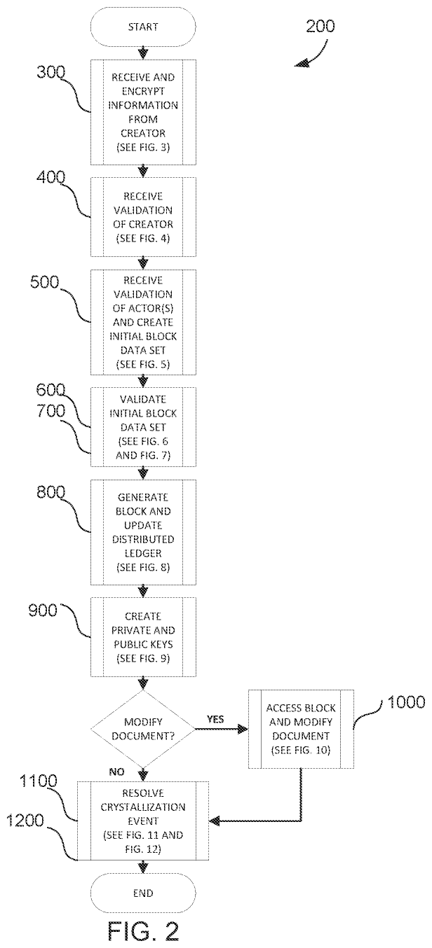

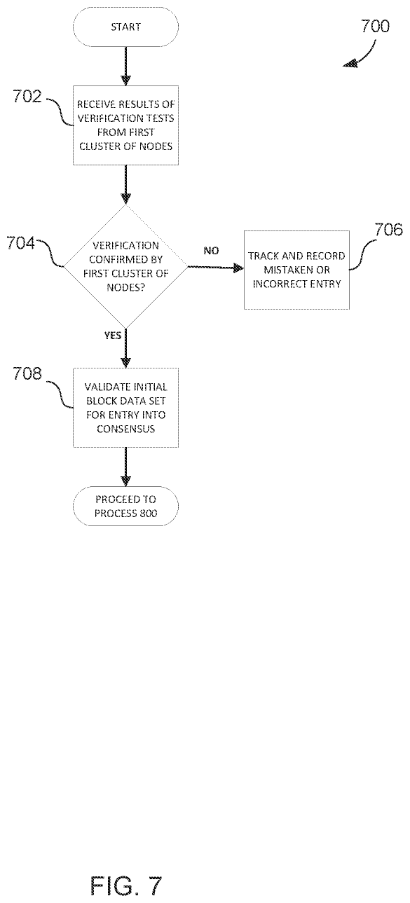

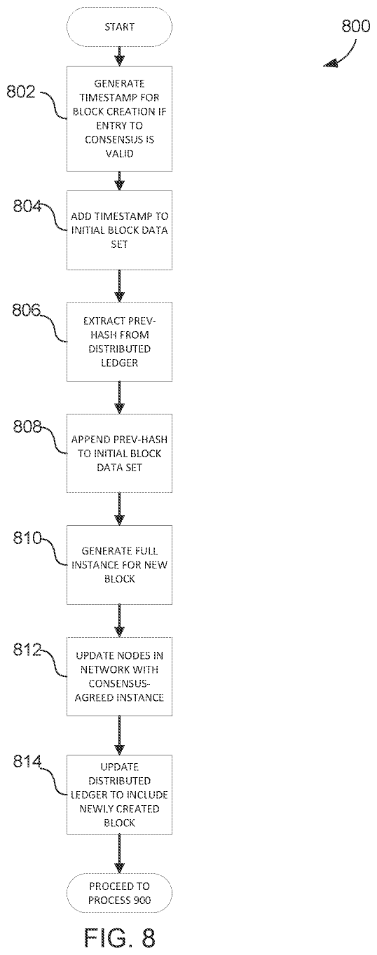

FIG. 2 shows an exemplary overview of the system process 200, according to one embodiment of the present disclosure. In various embodiments, at process 300 the system or a user device may receive and encrypt information from the creator 102 (shown in further detail in connection with FIG. 3). In some embodiments, at process 400, the system or a user device may receive the validation of the creator 102 from the validator or actor 104 (as shown in further detail in connection with FIG. 4). In multiple embodiments, at process 500, the system or a user device may then receive the validation of the validator or actor 104 from the creator 102, and then create the initial block data set 106 (as shown in further detail in connection with FIG. 5). In at least one embodiment, at processes 600 and 700, the system may validate the initial block data set 106 (as shown in further detail in connection with FIGS. 6 and 7). In one or more embodiments, at process 800, the system may generate a new block and add the block to the distributed ledger 110 (as shown in further detail in connection with FIG. 8). In one embodiment, at process 900, the system creates public and private keys for block access (as shown in further detail in connection with FIG. 9). After the public and private keys are created and the new block is added onto the distributed ledger 110, in some embodiments, the creator may choose to access the new block and modify the document information (as shown in further detail in connection with FIG. 10). In various embodiments, a crystallization event may occur once the new block is added onto the distributed ledger 110, and the validator or actor 104 may resolve the crystallization event (as shown in further detail in connection with FIGS. 11 and 12).

As will be understood by one having ordinary skill in the art, the steps and processes shown in FIG. 2 (and those of all other flowcharts and sequence diagrams shown and described herein) may operate concurrently and continuously, are generally asynchronous and independent, and are not necessarily performed in the order shown.

As described in FIG. 3, an exemplary process 300 for receiving and encrypting creator 102 information is described, according to one embodiment of the present disclosure. In various embodiments, the creator 102 may first engage with the system. According to multiple embodiments, the creator 102 may engage with the system by downloading and interacting with an application on a computing device, by accessing the system via a web-enabled portal, or by having an authorized third-party engage with the application on behalf of the creator 102, etc. In one embodiment, an authorized third-party may be any individual that has access to the system.

According to one embodiment, at step 302 of process 300, the system may request that the creator 102 input certain information into the system. In various embodiments, the certain information may include the creator's identification data/information, at least one validator's identification requirements, digital asset/document information, and other similar types of information or data. In at least one embodiment, the digital asset information may include third party identification information and contact information, wherein the third parties may be necessary third parties to the document, third-party beneficiaries, or any other third party that the creator 102 of the document may desire to list in the document or digital asset. In multiple embodiments, the creator's identification data and the validator's identification requirements may include, but are not limited to, biometric, photographic, video, voice, signature data, or any other kind of data or combination thereof. In one embodiment, the creator 102 may input the information into the system using a guided user interface software.

As described at step 304, according to various embodiments, the system or a user device receives the creator's identification data and the at least one validator's identification requirements from the creator 102. In an alternate embodiment, the system may detect the identification data from the creator's electronic device or a third party source (e.g., a wireless carrier or credit bureau). In multiple embodiments, at step 306, the system or a user device receives the document/digital asset information from the creator 102. In one or more embodiments, the digital asset may be a will, estate document, power of attorney, trust, indication of future wishes, guardianship of relatives, living will, instructions relating to transfer of assets, healthcare record, healthcare data, an indication of personal preferences of a first actor, or system or hardware data pertaining to a first computing device of the first actor. In several embodiments, the digital asset information may be key information from the document, or metadata related to the individual, including but not limited to biometrics, geolocation, or any other data set relevant to the process that is capable of being recorded, or any combination thereof, or background systematic data. For example, in one embodiment, the digital asset information recorded by the system for a will document may be key information from the will document, metadata related to the will creator, and/or background systematic data.

In multiple embodiments, at step 308, the system may detect or identify third-parties listed in the document. If there are any third parties listed in the document by the creator 102, then, at step 310, in one embodiment, the system may extract the contact information for the necessary third parties from the underlying document if the creator 102 listed the third parties' contact information in the document. In one embodiment, the creator 102 may list a multiple third parties in the document, but define a subset of the listed third parties to be contacted after a crystallization event. In an alternate embodiment, the system may detect the contact information for the listed third parties in the document from the creator's electronic device or a third-party source. For example, in one embodiment, the document may list a third party that should be contacted in the case of a crystallization event, but the document may not list any contact information. In this case, in a further embodiment, the system may search public databases for the current contact information of the third party, such as tax records or phone books, or other such public database that may provide current contact information for individuals. In another alternate embodiment, the creator may define the third parties to be contacted after a crystallization event separately using the user interface of the document creation aspect of the system. In several embodiments, if there is no third party listed in the document, then the system may proceed to step 312. In one or more embodiments, in step 312, the system or a user device may receive confirmation that the created document is correct from the creator 102, wherein the created document being correct means that the creator is verifying that the document is true. In some embodiments, the confirmation that the digital asset is correct may be done by simultaneous video or sound recording that is automatically triggered by the system or triggered by the user, where the creator explains that he or she created the digital asset on a certain date and that it is valid and not made in duress. In at least one embodiment, the creator may then upload the video or sound recording and append the video or sound recording to the document information. In one embodiment, the confirmation that the document is correct may be done by signature, password, fingerprint, question and response, completion of predetermined sentence, or any other electronic confirmation process.

In various embodiments, at step 314, upon confirmation that the digital asset is correct, the system may encrypt the digital asset/document information, the identification information of the creator 102, and the identification requirements for the at least one validator 104. In at least one embodiment, the encryption creates one part of a potential block (sometimes referred to herein as the “Tx_Root”). In some embodiments, the Tx_Root may be the first part of the potential new block to be added to the distributed ledger 110. As will be understood and appreciated, the name “Tx_Root” is not intended to be limiting and is intended to refer to the initiating root of the respective block. In one embodiment, the encrypted digital asset data may be embedded in the Tx_Root. In multiple embodiments, the Tx_Root may encompass the creator's preferences, the creator's identification information, target actors, actor(s)'s responses, certain details of actors, verification steps undertaken, or any other data that the creator may input into the system.

As described in FIG. 4, an exemplary process 400 for receiving validation of the creator 102 is shown, according to one embodiment of the present disclosure. In multiple embodiments, the creator may engage with more than one validator or actor 104 for the same transaction. In various embodiments, the system or a user device receives the validation of the creator 102 from the validator 104. In several embodiments, the validator 104 may engage with the system. In some embodiments, the validator 104 may engage with the system by downloading an application on a computing device or by accessing the system via a web-enabled application. In one embodiment, the creator 102 may input the validator's contact information, wherein the system directly contacts the actor 104 to instigate engagement with the system. In at least one embodiment, once the actor 104 is engaged with the system, the actor's application or web application access on the actor's device may be directly connected to the system application or web application access on the creator's device, wherein encrypted data may be transferred from the system on one device to the system on the second device.

In multiple embodiments, at step 402, the system may request identification information from the actor 104. In one or more embodiments, the identification data requested by the system may correspond to or comprise the identification requirements for the validator 104 provided by the creator 102. In some embodiments, the identification information requested may include, but is not limited to, biometric, photographic, video, signature information, or any combination thereof.

In various embodiments, at step 404, once the validator 104 has input the requested identification data, the system may decrypt the creator identification data on the validator's device. In some embodiments, at step 406, the system may request that the validator 104 validate the creator's identification information. In one or more embodiments, the system may use the creator's identification data to establish a series of tasks, questions, or combination thereof, for the actor 104 to pass in order for the creator's identification to be validated, where either the creator 102 has input a corresponding correct answer or the system has generated a corresponding correct answer. In an alternate embodiment, the creator 102 may submit one or more questions or tasks into the system for the validator to answer or perform. In multiple embodiments, if there are multiple actors 104 in the transaction, each individual actor 104 may have the same or different questions or tasks, as determined by either the system or the creator 102. In several embodiments, a question may include questions about the relationship between the creator and actor, confirming details about the creator, or random questions. In one or more embodiments, a task may include drawing or coloring on a computing device, reading a diagram, or any other task that may be completed on a computing device. For example, a creator may create a series of one question and one task for an actor to answer, where the question is “What is the creator's favorite planet?” and the task is to color in the lines of some provided drawing. In one embodiment, the validator's correct affirmation of the information in the tasks or questions may confirm the validation, which confirms the creation of the Tx_Root.

At step 408, according to multiple embodiments, upon validation of the creator's identification, the system may generate a “nonce” for the new potential block. In one embodiment, the system may use the validator's identification data to create the nonce. In at least one embodiment, if the creator 102 has engaged more than one actor 104 to validate the creator, the system may generate the nonce using identification data from all of the actors 104. According to at least one embodiment, a nonce generally comprises a unique number used in creation of a “block.” In some embodiments, the nonce may be created in any multiple of ways using the identification data gathered from the validator 104, such as metadata from images, gestures, videos, or such other personal identification information from the validator 104, such as biometric information. In one embodiment, the system may encrypt the data from the validator 104, combine the data into a data set and transform the data set into a piece of code. In a further embodiment, the data set may be capable of being repeated after a crystallization event. In several embodiments, the identification data that makes up the nonce may be encrypted and digitalized. In one or more embodiments, the encrypted data in the nonce may be used should a crystallization event be challenged, or to prove validity, or to gain access to the block at a later date under a correct set of conditions, such as if the creator chooses to modify the document or during responses to challenges.

At step 410, in multiple embodiments, the system may encrypt the validator identification data and transmit the encrypted validator identification data from the validator's device or application to the creator's device or application.

As described in FIG. 5, an exemplary process 500 for receiving the validation of the validator 104 and creating an initial block data set 106 is shown, according to one embodiment of the present disclosure.

At step 502, in various embodiments, once the creator's application on a device associated with the creator has received the encrypted validator identification information from the validator's application, the system may decrypt the validator identification information on the creator's application.

In multiple embodiments, at step 504, the system or a user device may receive the validation of the validator's identification data from the creator 102. In one or more embodiments, the system may use the validator's identification data to establish a series of tasks, questions, or combination thereof, for the creator 102 to pass in order for the validator's identification to be validated, where either the validator 104 has input a corresponding correct answer or the system has generated a corresponding correct answer. In an alternate embodiment, the validator 104 may submit one or more questions or tasks into the system for the validator to answer or perform. In several embodiments, a question may include questions about the relationship between the creator 102 and actor, confirming details about the creator, or random questions. In one or more embodiments, a task may include drawing or coloring on a computing device, reading a diagram, or any other task that may be completed on a computing device.

In one embodiment, as part of the validation process of the validator's information, the creator 102 may set parameters and permissions for the validator's future access and use of the creator's ledger entry. In one or more embodiments, the parameters and permissions for the validator's future use may be stored in the nonce or appended to the block to be stored on the distributed ledger 110. For example, a creator 102 may have multiple actors 104 engaged in a single transaction, where the creator 102 wants one specific actor 104 to access and use the stored information from the creator's ledger entry before any of the other actors 104 engaged in the transaction can access the document. Continuing with the example, the creator 102 may set a parameter or permission so that the other actors 104 cannot access the stored information until the desired specific actor 104 accesses or uses the stored information.

In at least one embodiment, at step 506, the creator's correct affirmation of the validator information in the tasks or questions may confirm the validation, which confirms the creation of the nonce.

At step 508, according to various embodiments, once the system confirms the nonce creation, the system adds the nonce to the Tx_Root to create the initial block data set 106. In several embodiments, the system may add the nonce to the Tx_Root using the creator's application, the validator's application, or any approved third party application. In one embodiment, the Tx_Root and nonce may be added together end-to-end. In an alternate embodiment, the Tx_Root and nonce could be combined and tokenized to create some data set that represents the initial block.

In FIG. 6, an exemplary process 600 for validating the initial block data set 106 is shown, according to one embodiment of the present disclosure.

At step 602, according to multiple embodiments, the resulting initial block data set 106 from step 508 may signal the system to generate a profile representing a primary node, wherein the primary node may correspond to a device operating the creator's application, the validator's application, or a third party's application (e.g., an application operating software capable of performing the processes described herein). In one embodiment, the primary node may be the central node to the node network 108 for the distributed ledger 110 for the new potential block. In some embodiments, “nodes” are devices running or accessing the ledger software or ledger application and can be operated by users, professional partners, or one or more central servers.

In various embodiments, at step 604, the system may initiate communication with a node network 108 through either the creator's application, the validator's application, or a third party's application or centralized node. In one embodiment, the node network 108 may be represented by localized user applications or centralized third party systems or centralized private systems, or any combination thereof. In several embodiments, a node is a user's computing device that is connected to or is using the disclosed software described by the present disclosure. In at least one embodiment, the node network 108 is all of the nodes using the software described in the present disclosure.

In multiple embodiments, at step 606, the system may initiate communication with a first cluster of secondary nodes in the network for validation operations. In several embodiments, a secondary node is a node in the node network 108 that is not the primary node. In some embodiments, the first cluster of secondary nodes is a predefined number of secondary nodes, where the predefined number may be a subset of the total nodes in the node network 108. For example, in one embodiment, the distributed ledger 110 system may have one hundred nodes, and the predefined number of nodes for the first cluster of secondary nodes is ten nodes. In another embodiment, the predefined number of nodes for the first cluster of nodes may be a percentage of total nodes in the system. In several embodiments, validation operations are used to verify whether the new potential block (i.e., the block created via the steps and processes described previously in connection with FIGS. 3-5) may be allowed onto the distributed ledger 110. In at least one embodiment, the system may confirm the number of nodes in the first cluster of nodes and may lock in the confirmed nodes in the first cluster of nodes. In one or more embodiments, the first cluster of nodes may be a cluster of secondary nodes.

In one or more embodiments, at step 608, once the first cluster of nodes are locked in, the system may transmit the initial block data set 106 to the first cluster of nodes for validation operations. In some embodiments, each node in the first cluster of nodes may analyze the information on the initial block data set 106 to determine where on the distributed ledger 110 the new block should be added. In at least one embodiment, the nodes in the first cluster of nodes may agree as to what the blockchain should look like from a sequencing view and the order of priority of ledger entry requests. In one embodiment, the nodes on the first cluster of nodes may look at certain system defined parameters, such as a timestamp and/or location, or other type of parameter, on the initial block data set 106 to determine the order of priority for ledger entry requests.

In FIG. 7, an exemplary process 700 for validating the initial block data set 106 for entry into the consensus is shown, according to one embodiment of the present disclosure.

At step 702, in several embodiments, once the first cluster of nodes receives the initial block data set 106 from the system or a user device, the nodes in the first cluster of nodes may use the information in the initial block data set 106 to perform the validation operations. In one or more embodiments, a secondary node in the first cluster of nodes may successfully validate the verification test upon confirming an acceptable or predefined number of verification tests. For example, in one embodiment, the system may have a predefined success rate of 2 out of 3 tests, wherein a node must successfully confirm 2 out of 3 verification tests for a specific initial block data set 106 for the specific initial block data set 106 to be validated. In at least one embodiment, substantially all of the nodes from the first cluster of nodes perform the verification tests. In some embodiments, the system or a primary node receives the results of the verification tests from the first cluster of nodes. As the number of transactions on the distributed ledger system increases, in one embodiment, the number of nodes required for the verification tests to be valid may increase linearly.

At step 704, in various embodiments, the system analyzes the verification test results for the specific initial block data set 106. In some embodiments, if the initial block data set 106 is not confirmed, because the threshold number of secondary nodes in the first cluster of nodes did not confirm the verification test, then, at step 706, the system may track and record the mistaken or incorrect entry. In one embodiment, the system may track and record the mistaken or incorrect entry for a possible statistical return of the confidence against the initial block likely to be truly valid.

If the initial block data set 106 is confirmed by the predefined number of secondary nodes, then, at step 708, according to multiple embodiments, the system may validate the initial block data set 106 for entry into the consensus. In one embodiment, the required amount of secondary nodes may be a predefined number of secondary nodes or may be a predefined percentage of total nodes that ran the verification tests. As discussed within this disclosure, a “consensus” generally refers to the fact that the nodes on the network are in agreement on the state of the distributed ledger 110 and location of the potential new block on the chain. The consensus methodology follows a set of rules achievable by any combination of the number of nodes agreeing on the timestamp and previous block.

In FIG. 8, an exemplary process 800 for generating a new block and updating the distributed ledger 110 is shown, according to one embodiment of the present disclosure.

At step 802, in various embodiments, once the system validates the initial block data set 106 for entry onto the consensus, the system may generate a timestamp for the initial block data set 106. In one embodiment, the timestamp may be the equivalent time in the GMT zone. In at least one embodiment, the system may store the timestamp in a secondary system in case of later verification issues. In one embodiment, the secondary system may be a secondary distributed ledger 110, separate server, or any other electronic storage unit.

Proceeding to step 804, in at least one embodiment, once the system generates the timestamp, the system adds the timestamp to the initial block data set 106. Continuing to step 806, in multiple embodiments, the system extracts a prev-hash from the distributed ledger 110. As referred to in this disclosure, a “prev-hash” is generally a segment or part of the block that is one block immediately prior to the current block in the distributed ledger 110. In some embodiments, the prev-hash may lock in the new block's location within the distributed ledger 110, since part of the new block may in turn form part of the next block in the chain.

At step 808, according to various embodiments, the system may add the prev-hash to the initial block data set 106 and timestamp. In several embodiments, at step 810, the addition of the prev-hash and timestamp to the initial block data set 106 creates a full instance for the new block, meaning that the new block exists. In one embodiment, the full instance for a new block is the combination of the initial block data set 106 (which is a combination of the Tx_Root and nonce), the timestamp, and the prev-hash.

At step 812, in multiple embodiments, the system may update the nodes in the network to include the consensus-agreed full instance. At step 814, the system may update the distributed ledger 110 to include the newly created block.

In FIG. 9, an exemplary process 900 for generating public and private keys is shown, according to one embodiment of the present disclosure. In certain embodiments, a key may be a function of the personal identification information collected from the relevant actor earlier in the process. For example, in one embodiment, the creator public and private keys may be a function of the creator's identification information inputted into the system earlier in process 300, and the validator public and private keys may be a function of the validator's identification data/information inputted into the system in process 400. In some embodiments, the key may be the actor's biometric information or identification in forms as suggested in previous steps. In at least one embodiment, a key may be created locally from the actor's application using the actor's multifactor identification, meaning that the actor himself is the key, and therefore is always in possession of his or her personal key.

Once the system has updated the distributed ledger 110 to include the new block, then, at step 902, in multiple embodiments, the system may generate creator public and private keys. At step 904, in several embodiments, the system may generate validator public and private keys.

Once the keys are generated, in various embodiments, at step 906, the system may transmit the creator public and private keys and record identification to the creator 102. Continuing to step 908, in several embodiments, the system may transmit the validator public and private keys and record identification to the validator 104. At step 910, in one embodiment, the system may generate a secondary key for the block. At step 912, in at least one embodiment, the system may store the secondary key in a backup server or similar electronic storage system.

In FIG. 10, an exemplary process 1000 for modifying a block on the distributed ledger 110 is shown, according to one embodiment of the present disclosure.

At step 1002, in various embodiments, the system receives a query from the creator 102 of a specific block, or an actor authorized by the same creator 102, for the modification of the document on the specific block by using the creator private key and record identification.

Proceeding to step 1004, in multiple embodiments, the system may confirm the identification of the creator 102 by extracting the personal identification information stored in the Tx_Root and comparing the extracted information with the creator's private key information. In some embodiments, the Tx_Root stores the identification information of the creator 102.

At step 1006, according to various embodiments, upon the confirmation of identification, the system may decrypt the specific block queried on the distributed ledger 110, wherein the creator 102 may view the stored version of the digital asset.

At step 1008, according to multiple embodiments, the process for modification and entry of the modified block onto the distributed ledger 110 is the same as in processes 200-900. At step 1010, according to at least one embodiment, the modified block, once it is validated for entry onto the consensus, is added to the distributed ledger 110. In one embodiment, the modified block is added to the distributed ledger 110 as a new block, where the timestamp and location on the blockchain are different than the original block that stored the digital asset that was modified. In a further embodiment, the system may note that the original block has been superseded.

As shown in FIG. 11, an exemplary process 1100 for resolving a crystallization event is shown, according to one embodiment of the present disclosure. In multiple embodiments, a crystallization event may be an event which requires notification to the third parties listed in the document on the distributed ledger 110. For example, in one embodiment involving wills or estate documents, the crystallization event may be the death of the will creator 102.

In various embodiments, at step 1102, the system may receive a query from the validator 104 for the digital asset on a specific block, using the validator public and private keys and record identification. Continuing to step 1104, in some embodiments the system may confirm the identification of the validator 104 by using the information stored in the nonce as a comparison tool. At step 1106, in at least one embodiment, the system may request the validator 104 to provide proof of the crystallization event. At step 1108, in one embodiment, the system may receive proof of the crystallization event. In one or more embodiments, the proof of the crystallization event may be a simple question and answer about whether the creator is dead, a death certificate, an engagement letter, a judicial decree, doctor's note or any other type of proof as determined by the situation of the particular crystallization event. In several embodiments, upon a validator 104 attempting to access the block due to a crystallization event, the system may send a message, such as through email, text messaging, or any other type of communication, to determine if the creator 102 is responsive, where if the creator is unresponsive to the message, the system allows the validator 104 to access the stored document. In a further embodiment, the document/digital asset information may have some information that is needed quickly upon a crystallization event that requires a lesser amount of evidence to access, and other information that may require better evidence to access. For example, in one embodiment, a validator 104 may only be required to answer the question “Is the creator 102 dead?” to access the funeral requirements in the stored document, but may be required to upload a death certificate to the system before accessing the entire document. In another embodiment, the system may, upon a validator 104 attempting to access the ledger entry on the blockchain, search public records to determine whether a crystallization event has occurred.

In multiple embodiments, at step 1110, the system, upon validation of the validator 104 and crystallization event, may recover and decrypt the digital asset in the queried block from the distributed ledger 110. In several embodiments, the validator 104 may view the stored version of the document once the document has been decrypted.

In FIG. 12, an exemplary process 1200 for contacting third parties during a crystallization event is shown, according to one embodiment of the present disclosure.

In various embodiments, at step 1202, the system may ascertain the contact information of the third parties listed in the document. In one embodiment, the system may receive the contact information from the list in the document, or the system may use third party databases to acquire the contact information for the listed third parties in the document.

Continuing to step 1204, in multiple embodiments, the system may transmit a communication to any listed necessary third parties in the document. In one embodiment, the communication may notify third parties that they are listed in the document. In another embodiment, the communication may notify the third parties of other information, such as the validator's information or other information listed in the document.

At step 1206, according to various embodiments, the system processes the decrypted digital asset data into a readable document. At step 1208, in multiple embodiments, the system may transmit the readable document to the necessary third parties listed in the document. In another embodiment, the system may transmit the readable document to all third parties listed in the decrypted document.

In an additional embodiment, the system may have the ability to implement conditionality as to the number, type, or another specific requirement for the creator 102. In various embodiments, the system having the ability to implement conditionality for creators 102 attempting to add a block to the distributed ledger 110 may permit the system to allow or deny further entries into the distributed ledger 110 subject to a creator 102 passing or failing the given condition. For example, in one embodiment, the system may only allow a creator that is a member of a particular association, or domiciled or born in a particular country, of a certain age, or a particular mental capacity, or any other category that could be used to group actors or groups, to add a block to the distributed ledger 110. In some embodiments, the restrictions or conditions for entry into the distributed ledge 100 may be set in the genesis ledger entry or later entry. In at least one embodiment, the conditionality for entry into the distributed ledger 110 may increase security and resilience and allow the distributed ledger 110 to deal with a number of specific implementations and requirements of particular groups or actors.

In another additional embodiment, because many jurisdictions differ in their requirements or restrictions for estate planning or will creation, each jurisdiction may have a distributed ledger 110 for storing estate planning documents, such as wills or trusts, designated to it for the users within the jurisdiction. In various embodiments, a jurisdiction could be a county, state, region, canton, parish, country, or groups, or any other way jurisdictions could be divided and grouped. In multiple embodiments, a parallel distributed ledger may allow for secondary country blocks, selection(s) of countries, region(s) or canton(s), state(s) and land masses to claim priority other over distributed ledgers as to the jurisdiction governance of the creator's assets. In several embodiments, the creator 102 or the validator 104 may select the secondary distributed ledgers to add a block on at the beginning of the block creation process. In one embodiment, having parallel distributed ledgers allows the disclosed system to deal with multiple distinct and shared jurisdictional requirements or restrictions in a global context.

In another additional embodiment, after a block has been added to the distributed ledger 110, the creator 102 or actors 104 associated with the block may promote the block to another relevant distributed ledger or group of distributed ledgers. For example, in one embodiment, a will creator 102 may have added his or her will to a distributed ledger 110 associated with wills in a specific jurisdiction, where the jurisdiction is the country where the will creator 102 currently lives. Continuing the example, if the will creator 102 moves to a different country, then, in one embodiment, the will creator 102 may promote the block associated with the will creator's will to the distributed ledger associated with wills in the new jurisdiction/country.

In a further embodiment, a distributed ledger 110 may be created such that it only has a finite number of available spaces or locations for ledger entries. In various embodiments, the system may allocate a creator 102 a random free space on the distributed ledger, where the location of the new block may not have a prev-hash associated with the block one space ahead of the new block. In at least one embodiment, the number of spaces on the distributed ledger 110 may be flexible, where the total number of ledger entry spaces on the blockchain may increase or decrease depending on a secondary criteria. For example, in one embodiment, but not to limit the type of secondary criteria, if the number of births out number deaths in a country then the total number of available ledger entries would increase by the difference in the increased number of births to deaths. In multiple embodiments, the timestamp of the ledger entry and allocated entry point within the distributed ledger 110 are recorded when an empty block space is filled, which increases security by obscuring the location of next block. For example, in one embodiment, if a blockchain has 100 spaces for ledger entries, numbered sequentially 1-100 on the blockchain, the previous ledger entry may have been at location 78, and the next ledger entry may be at location 27, where the new block at location 27 records that location 78 was the last entry point. In several embodiments, the location allocation can be done via request at time of block creation, hidden in the application itself or attached a third-party system or any other technique.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

1. A method for managing digital assets on a distributed ledger, comprising:
receiving and/or generating first data at a first computing device associated with a first actor, the first data comprising first identification data corresponding to the first actor, identifying data corresponding to a second actor, and digital asset data defining a digital asset to be maintained on the distributed ledger;
transmitting the first identification data to a second computing device associated with the second actor;
receiving and/or generating second data at the second computing device, the second data comprising second identification data corresponding to the second actor and a confirmation that the second actor has performed a successful validation operation of the first identification data;
transmitting the second identification data to the first computing device;
receiving and/or generating a confirmation at the first computing device that the first actor has performed a successful validation operation of the second identification data;
generating a block data set based on the first identification data, the second identification data, and the digital asset data; and
adding the block data set to the distributed ledger.

2. The method of claim 1, further comprising:
encrypting the first identification data prior to transmitting the first identification data to the second computing device; and
enabling decryption of the first identification data at the second computing device upon determination of authorized access to the first identification data by the second actor.

3. The method of claim 1, further comprising:
encrypting the second identification data prior to transmitting the second identification data to the first computing device; and
enabling decryption of the second identification data at the first computing device upon determination of authorized access to the second identification data by the first actor.

4. The method of claim 1, wherein the successful validation operation of the first identification data comprises confirmation of one or more correct answers and/or actions to one or more validation questions and/or validation tasks from the second actor with respect to the first identification data.

5. The method of claim 1, wherein the successful validation operation of the second identification data comprises confirmation of one or more correct answers and/or actions to one or more validation questions and/or validation tasks from the first actor with respect to the second identification data.

6. The method of claim 1, further comprising, prior to adding the block data set to the distributed ledger:
transmitting the block data set to a plurality of computing devices affiliated with the distributed ledger; and
receiving confirmation from one or more of the plurality of computing devices that the block data set is valid.

7. The method of claim 6, wherein the one or more of the plurality of computing devices do not include the first computing device or the second computing device.

8. The method of claim 6, further comprising:
generating a timestamp corresponding to generation of the block data set; and
appending the timestamp to the block data set.

9. The method of claim 8, further comprising:
extracting a prev-hash from the distributed ledger; and
appending the prev-hash to the block data set.

10. The method of claim 9, further comprising updating the block data set on the distributed ledger to include the timestamp and the prev-hash.

11. The method of claim 1, further comprising generating a first private key for the first actor, wherein the first private key is generated as a function of the first identification data, and wherein the first private key is necessary to access the digital asset in the block data set maintained on the distributed ledger.

12. The method of claim 11, further comprising:
receiving and/or generating a request for modification of the digital asset at a computing device associated with the first actor, wherein the request includes the first private key and an indication of the block data set comprising the digital asset;
accessing the block data set on the distributed ledger using the first private key;
enabling access to the block data set to the first actor for modification of the block data set; and
upon modification, updating the block data set on the distributed ledger.

13. The method of claim 1, further comprising generating a second private key for the second actor, wherein the second private key is generated as a function of the second identification data, and wherein the second private key is necessary to access the digital asset in the block data set maintained on the distributed ledger.

14. The method of claim 13, wherein the digital asset data includes one or more third parties to be given access to the digital asset upon a crystallization event.

15. The method of claim 14, further comprising, upon the crystallization event:
receiving and/or generating a request for access to the digital asset at a computing device associated with the second actor, wherein the request includes the second private key, an indication of the block data set comprising the digital asset, and proof of the crystallization event;
accessing the block data set on the distributed ledger using the second private key;
upon successful access to the block data set based on the second private key, retrieving the digital asset from the block data set; and
transmitting the digital asset to the one or more third parties.

16. The method of claim 1, wherein the digital asset comprises a will, estate document, power of attorney, trust, indication of future wishes, guardianship of relatives, or living will.

17. The method of claim 1, wherein the digital asset comprises instructions relating to transfer of assets.

18. The method of claim 1, wherein the digital asset comprises a healthcare record or healthcare data.

19. The method of claim 1, wherein the digital asset comprises an indication of personal preferences of the first actor.

20. The method of claim 1, wherein the digital asset comprises system or hardware data pertaining to the first computing device of the first actor.
